(19) United States
(12) Patent Application Publication
(10) Pub. No.: US 2014/0340437 A1
(43) Pub. Date: Nov. 20, 2014

(54) VIDEO DISPLAY DEVICE

(71) Applicant: Seiji Kohashikawa, Osaka-shi (JP)

(72) Inventor: Seiji Kohashikawa, Osaka-shi (JP)

(73) Assignee: SHARP KABUSHIKI KAISHA, Osaka-shi, Osaka (JP)

(21) Appl. No.: 14/364,254

(22) PCT Filed: Aug. 22, 2012
(86) PCT No.: PCT/JP2012/071188

§ 371 Date: Jun. 10, 2014

(30) Foreign Application Priority Data
Dec. 26, 2011 (JP) 2011-282590

(51) Int. Cl. G09G 3/34; G09G 3/36

(52) U.S. Cl. CPC G09G 3/3406; G09G 3/36; G09G 2300/026; G09G 2320/062; G09G 2320/0686; G09G 2320/0233
USPC 345/694; 345/102

(57) ABSTRACT

A display device uses a plurality of monitors to constitute a single image, achieves high contrast and, suppresses variations in luminance among the monitors. Each monitor is provided with an image analysis portion that finds a first feature quantity in a video display region corresponding to a region of an LED backlight, and a gradation control portion that determines a first luminance level for the corresponding LEDs region and calculates a luminance stretch quantity for stretching the first luminance levels uniformly. A microcomputer selects a minimum luminance stretch quantity from among the monitors and outputs the selected minimum luminance stretch quantity to the monitors. The gradation control portion for each monitor stretches the first luminance levels uniformly to determine a second luminance level on the basis of the minimum luminance stretch quantity acquired from the microcomputer.

### TECHNICAL FIELD

The present invention relates to a video display device, and more specifically to a video display device in which a single screen is constituted by a plurality of monitors.

### BACKGROUND OF THE INVENTION

Conventionally, a multi-display device has been known that a plurality of video display devices are arrayed in a vertical and horizontal matrix shape and divided images are displayed on each of the video display devices to constitute a large single screen all together. In such a multi-display device, unevenness in luminance easily occurs among screens so that various methods for solving unevenness in luminance have been proposed. For example, Patent Document 1 describes a technology for controlling luminance of a light source in order to solve unevenness in luminance among screens in a multi-display device. Specifically, each video display portion constituting the multi-display device has a backlight portion having a plurality of light sources for forming a video on the video display portion, and light quantity regulating means for regulating lightness of the light sources in the backlight portion. Further, the lightness of each backlight is able to be individually controlled by this light quantity regulating means.

Moreover, a liquid crystal display is adopted also in the multi-display device as described above, and one using an LED backlight for illumination of the liquid crystal display is prevalent. In the case of the LED backlight, there is an advantage that local dimming is possible. In the local dimming, a backlight is divided into a plurality of regions to control light emission of an LED for each region according to a video single of each region. For example, such control becomes possible that light emission of an LED is suppressed for a dark part in a screen and an LED is caused to emit light with high intensity for a bright part in the screen. This makes it possible to reduce power consumption of the backlight as well as to improve contrast of a display screen.

For example, exemplary control of conventional local dimming is shown in FIG. 10. Here, a backlight is divided into eight regions, and luminance of an LED is controlled according to a maximum gradation value of a video signal corresponding to each region. Moreover, it is set that the maximum gradation value of the video signal of each region is in a state shown in FIG. 10(A). A to H indicate region Nos. and a number below each of them is a maximum gradation value in each region. For example, luminance of the LED in each region by the local dimming becomes as shown in FIG. 10(B). That is, luminance of the LED is controlled for each region according to the video single of each region. Here, since a video is relatively dark in a region where the maximum gradation value of the video signal is low, the luminance of the LED is lowered to reduce black float and improve contrast as well as to reduce power consumption of the LED. In this case, maximum luminance in each region is limited to luminance when all LEDs of the backlight are lit with a duty of 100% (for example, 450 cd/m²).

### PRIOR ART DOCUMENT

### Patent Documents

Patent Document 1: Japanese Laid-Open Patent Publication No. 2009-169196

### SUMMARY OF THE INVENTION

### Problem to be Solved by the Invention

As described above, in the conventional local dimming control that a backlight is divided into a plurality of regions to control luminance of an LED according to a video signal corresponding to each region, maximum luminance in each region is limited to luminance when all LEDs of the backlight is lit with a duty of 100% and the luminance of the LED is controlled according to the video signal within the limit. Therefore, for example, when trying to improve contrast by making a bright video brighter uniquely, there are limitations.

On the other hand, a method is considered that PWM (Pulse Width Modulation) control is performed so that power does not exceed a prescribed value, and when an area in which the LED is lit is small, power is supplied locally to enhance peak luminance. This method makes it possible to provide higher luminance compared to normal local dimming. When this method is applied to each monitor of the multi-display device described above, however, there is a problem that variations in luminance occur among the monitors. For example, assumed is a case where a single screen is constituted by four monitors 1 to 4 as shown in FIG. 11 and a monochromatic video is displayed thereon.

In FIG. 11, when gradation of a video signal (also referred to as pixel gradation) of a white circle part W is 255 and pixel gradation of other black part is 0, proportion of the white circle part W having peak luminance to the entire screen is low in screens of the monitors 1 and 3, and therefore a lit area of the LED becomes small. Thus, such control is performed that power is supplied locally to cause the LED to emit light with high intensity, and luminance of the white circle part W becomes high. On the other hand, proportion of the white circle part W to the entire screen is high in screens of the monitors 2 and 4, and therefore the lit area of the LED becomes large. Thus, control for causing the LED to emit light with low intensity is performed and the luminance of the white circle part W becomes low. By such control, variations in the luminance of the white circle part W in the monitors 1 to 4 occur.

The present invention has been made in view of circumstances as described above, and aims to make it possible, in a video display device in which a single screen is constituted by a plurality of monitors, to suppress variations in luminance among the monitors while achieving high contrast feeling, when a backlight is divided into a plurality of regions to control luminance of the backlight according to a video signal corresponding to each of the regions.

### Means for Solving the Problem

To solve the above problems, a first technical means of the present invention is a video display device in which a single screen is constituted by a plurality of monitors, wherein each of the monitors includes a display panel that displays a video signal, a backlight that uses an LED as a light source for illuminating the display panel, an image analysis portion that divides the backlight into a plurality of regions to acquire a first feature quantity of a video of a display region corresponding to each of the divided regions, and a gradation control portion that defines first luminance of the LED for each of the divided regions according to the first feature quantity acquired by the image analysis portion, and further calculates a luminance stretch quantity for stretching the first luminance uniformly in a range where a total value of LED drive current is equal to or less than a predetermined allowable current value, with respect to the first luminance for each of the divided regions, the video display device includes a control portion that selects a minimum luminance stretch quantity from among the luminance stretch quantities acquired from each of the monitors and outputs the selected minimum luminance stretch quantity to each of the monitors, and the gradation control portion of each of the monitors stretches the first luminance uniformly based on the minimum luminance stretch quantity acquired from the control portion to define second luminance for each region.

A second technical means is the video display device of the first technical means, wherein the image analysis portion of each of the monitors varies a lighting rate of a region of the LED corresponding to the divided region based on the first feature quantity of the video signal of the divided region and acquires an average lighting rate of the LED by averaging lighting rates of the regions of the LED for all regions of the LED, and the gradation control portion of each of the monitors acquires the luminance stretch quantity based on maximum possible display luminance on a screen of the display panel associated with the average lighting rate in advance.

A third technical means is the video display device of the first technical means, wherein the image analysis portion of each of the monitors acquires an APL of the video signal, and the gradation control portion of each of the monitors acquires the luminance stretch quantity based on maximum possible display luminance on a screen of the display panel associated with the APL in advance.

A forth technical means is the video display device of anyone of the first to the third technical means, wherein the gradation control portion of each of the monitors defines the second luminance by multiplying the first luminance by a fixed multiplying factor according to the minimum luminance stretch quantity, and acquires a maximum LED gradation value from maximum luminance of the second luminance.

A fifth technical means is the video display device of any one of the first to the forth technical means, wherein the first feature quantity is a maximum gradation value of the video signal in the divided region.

### Effect of the Invention

According to the present invention, in a video display device in which a single screen is constituted by a plurality of monitors, when a backlight is divided into a plurality of regions to control luminance of the backlight according to a video signal corresponding to each of the regions, a luminance ratio among regions is increased to improve contrast as well as power is supplied locally to enhance peak luminance when an area where the backlight is lit is small, and further luminance of a peak part (such as a white part) in each monitor is matched to luminance of a monitor where the luminance of the peak part becomes minimum, thus making it possible to suppress variations in luminance among the monitors while achieving high contrast feeling.

### BRIEF DESCRIPTION OF DRAWINGS

FIG. 1 is a diagram showing an exemplary screen of a video display device according to the present invention.

FIG. 2 is a diagram explaining an exemplary main configuration of the video display device shown in FIG. 1.

FIG. 3 is a diagram explaining exemplary setting of LED luminance by an area active control portion of a monitor.

FIG. 4 is a diagram explaining exemplary control of local dimming by power limit control.

FIG. 5 is a diagram showing a state of luminance on a liquid crystal panel when a luminance duty of an LED is shifted.

FIG. 6 is a diagram showing an example that a display screen is divided into eight.

FIG. 7 is a diagram explaining exemplary setting of LED luminance by an area active control portion of a monitor.

FIG. 8 is a diagram explaining exemplary control when power limit control is performed individually for each monitor.

FIG. 9 is a diagram explaining exemplary control of power limit control by the video display device according to the present invention.

FIG. 10 is a diagram explaining control of conventional local dimming.

FIG. 11 is a diagram showing a screen in a case where a single screen is constituted by a plurality of monitors.

### PREFERRED EMBODIMENT OF THE INVENTION

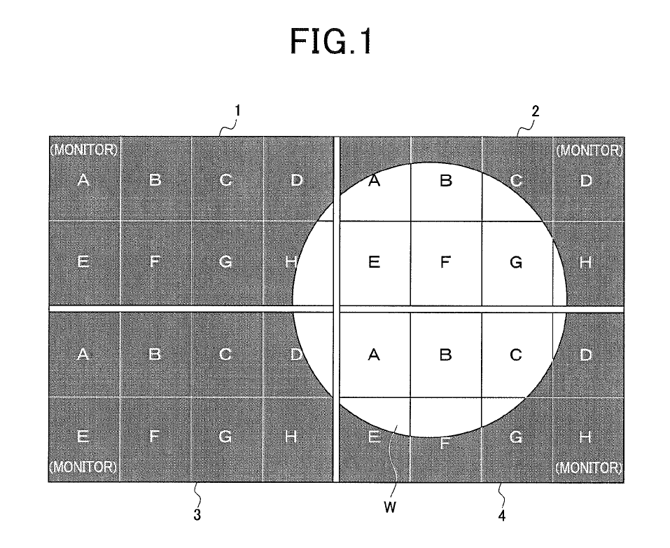

Hereinafter, preferred embodiments according to a video display device of the present invention will be described with reference to accompanying drawings. An exemplary screen of the video display device according to the present invention is shown in FIG. 1. In the video display device of the present example, a single screen is constituted by four monitors 1 to 4, and a display screen of each of the monitors 1 to 4 is divided into eight regions A to H, respectively.

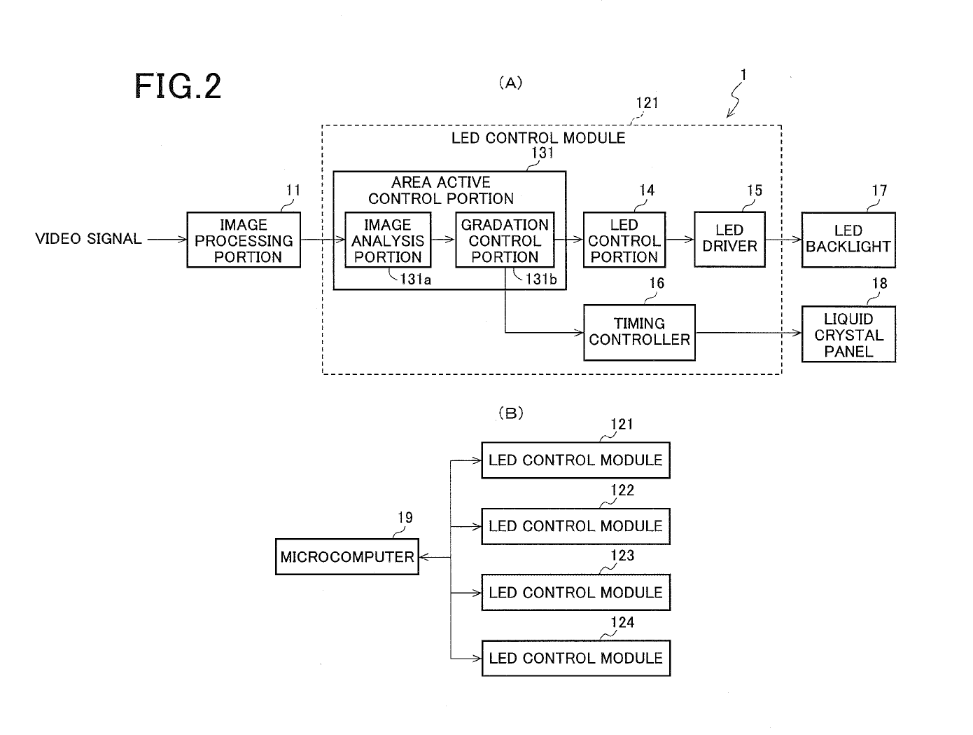

FIG. 2 is a diagram explaining an exemplary main configuration of the video display device shown in FIG. 1. FIG. 2(A) is a diagram showing an exemplary main configuration of a monitor 1, and other monitors 2 to 4 are also basically the same in the configuration, so that the monitor 1 is exemplified as a representative. In the figure, 11 denotes an image processing portion, 121 denotes an LED control module, 17 denotes an LED backlight, and 18 denotes a liquid crystal panel. The LED control module 121 is provided with an area active control portion 131, an LED control portion 14, an LED driver 15, and a timing controller 16. Moreover, as shown in FIG. 2(B), the monitors 1 to 4 are provided with LED control modules 121 to 124, respectively, and the LED control modules 121 to 124 are connected to a microcomputer 19.

Hereinafter, description will be given for a case where power limit control is performed independently at each of the monitors 1 to 4, taking the monitor 1 as an example. In FIG. 2(A), the image processing portion 11 inputs a video signal separated from a broadcast signal or a video signal from an external device and performs the same conventional video signal processing. For example, IP conversion, noise reduction, scaling processing, γ processing, white balance adjustment and the like are executed as appropriate. Further, contrast, color hue and the like are adjusted based on a user setting value for outputting.

The area active control portion 131 is provided with an image analysis portion 131a and a gradation control portion 131b. When a video signal is input from the image processing portion 11, the image analysis portion 131a acquires a first feature quantity of a video in a display region corresponding to each divided region, which is a region that the LED backlight 17 is divided into a plurality of regions. The first feature quantity is a maximum gradation value of the video signal in the divided region, for example. Moreover, the image analysis portion 131a varies a lighting rate of a region of the LED backlight 17 corresponding to the divided region based on the first feature quantity of the video signal of the divided region and averages lighting rates of LED regions for all LED regions to thereby acquire an average lighting rate of the LED backlight 17. Then, the image analysis portion 131a outputs the maximum gradation value (first feature quantity) for each region, which is acquired above, to the gradation control portion 131b as LED data and outputs the average lighting rate of the LED backlight 17 to the gradation control portion 131b.

Moreover, in the image analysis portion 131a, data showing gradation of each pixel of liquid crystal is output to the gradation control portion 131b as liquid crystal data. The liquid crystal data at this time and the LED data are output so that synchronization of the LED backlight 17 and the liquid crystal panel 18 for final output is kept.

Note that, the LED data is set as the maximum gradation value of the video signal for each divided region, but may not be the maximum gradation value and may be other predetermined statistic such as an average gradation value of the video signal in the divided region, for example. A maximum gradation value in a region is generally used as the LED data, and description will be given below as using the maximum gradation value in the divided region.

Based on the LED data (maximum gradation value for each divided region) output from the image analysis portion 131a and the average lighting rate of the LED backlight 17, the gradation control portion 131b performs power limit control to determine a control value for controlling lighting of each LED of the LED backlight 17 (hereinafter, referred to as LED gradation value). Then, the LED control portion 14 outputs a control signal based on the LED gradation value determined by the gradation control portion 131b, and the LED driver 15 controls light emission of each LED of the LED backlight 17 in accordance with the control signal output from the LED control portion 14.

Moreover, the gradation control portion 131b determines a control value for controlling gradation of each pixel of liquid crystal (hereinafter, referred to as pixel gradation value) based on the liquid crystal data output from the image analysis portion 131a. Then, the timing controller 16 outputs a control signal based on the pixel gradation value determined by the gradation control portion 131b to control gradation of each pixel of the liquid crystal panel 18.

Here, the power limit control is for further enhancing luminance of the backlight with respect to a region that needs more luminance in a display screen to improve contrast, in which a total quantity of drive current when LEDs of the backlight are completely lit is set to an upper limit, and light emission luminance of the LED is increased in a range where a total quantity of drive current of LEDs that are lit in each region does not exceed this total quantity of drive current when completely lit.

The luminance of the LED of the LED backlight 17 is able to be controlled by PWM (Pulse Width Modulation) control or current control, or a combination thereof. In any case, control is performed to cause the LED to emit light with desired luminance. In the following example, description will be given taking duty control by PWM as an example. The LED gradation value output from the gradation control portion 131b is for performing light emission control of the LED for each divided region of the area active control portion 131, thereby achieving local dimming.

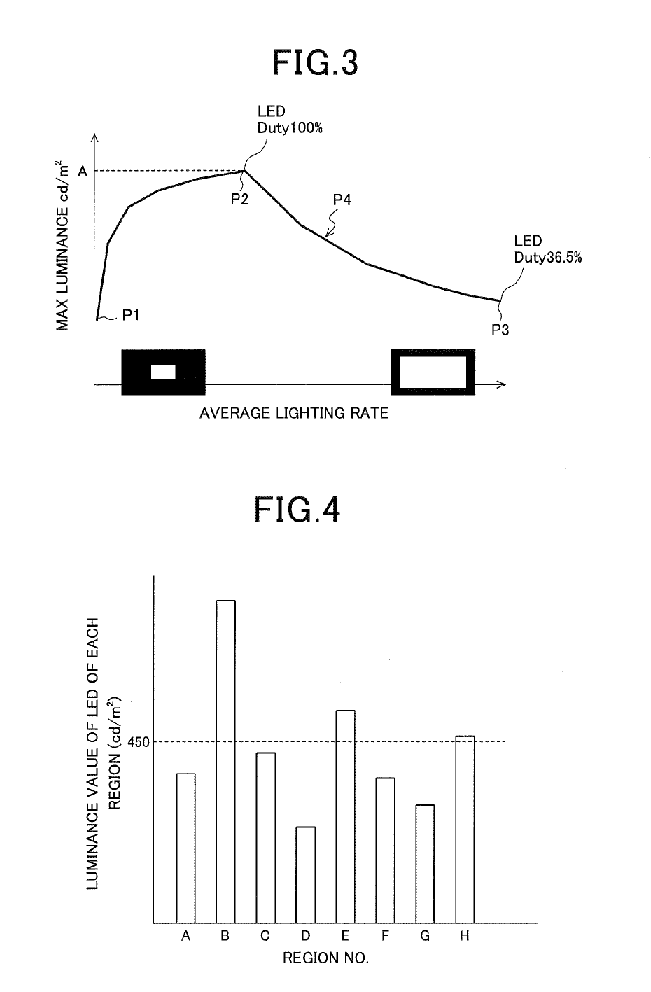

FIG. 3 is a diagram explaining exemplary setting of LED luminance by the area active control portion 131 of the monitor 1. The gradation control portion 131b of the area active control portion 131 determines luminance of the LED backlight 17 based on a control function (graph) as shown in FIG. 3. A horizontal axis is an average lighting rate (window size) of the LED backlight 17. A lighting rate is for defining an average lighting rate of the entire backlight, and is able to be represented as a ratio of a completely lit region (window region) to an unlit region. The lighting rate is 0 in a state of having no lit region indicating the window region, and the lighting rate increases as a window of a lit region becomes larger and the lighting rate reaches 100% when completely lit.

Here, the LED backlight 17 is constituted by a plurality of LEDs, and is able to control luminance for each region. The lighting rate in each region of the LED backlight 17 is determined by a predefined operation expression based on a maximum gradation value in each region, in which operation is performed in such away as to keep luminance of the LED without lowering basically in a bright high-gradation region with a maximum gradation value while lowering luminance of the LED in a dark low-gradation region with a maximum gradation value.

Then, the image analysis portion 131a of the area active control portion 131 calculates an average lighting rate of the entire LED backlight 17 from a lighting rate of each region, and according to the average lighting rate, the gradation control portion 131b calculates a luminance stretch quantity of maximum light emission luminance of the LED backlight 17 by a predetermined operation expression and a table. A vertical axis of FIG. 3 is Max luminance (cd/m²), which indicates maximum possible screen luminance after stretching in the case of the maximum gradation value in all regions in a screen. That is, the vertical axis indicates maximum display luminance on the screen, for indicating luminance of a region that possibly has maximum display luminance among the plurality of divided regions, that is, luminance of a region including a window in the screen. Since the above-described luminance stretch quantity is a value determined by the average lighting rate, and the Max luminance is a value determined by the luminance stretch quantity, it may be said that the Max luminance is a value determined according to the average lighting rate, as exemplified in the graph of FIG. 3.

That is, this FIG. 3 shows an example of the control function indicating a relation of Max luminance with respect to the average lighting rate of the LED backlight 17. As to the average lighting rate of the entire LED backlight 17, the average lighting rate is 0 in a state of having no lit region, and the average lighting rate reaches 100% when completely lit. The control function of FIG. 3 is stored in a not-shown memory, and is referred to based on the average lighting rate of the LED backlight 17, which is acquired from a video signal.

Here, it is set that power for lighting the LED (total quantity of drive current values) by power limit control is fixed. Accordingly, as the average lighting rate increases, power that is able to be supplied to a single divided region becomes small. In a range where the average lighting rate is small (for example, P1 to P2), it is possible to concentrate power to the small window, so that each LED is controlled with a duty of 100% at P2 to allow lighting with Max luminance A. Note that, in a range where the average lighting rate is P1 to P2, the lit region is small, so that lighting with the Max luminance A is possible, however, this causes a problem that a low-gradation part also becomes bright and black float becomes prominent. Therefore, in the example of FIG. 3, Max luminance is reduced as the average lighting rate becomes smaller in the range where the average lighting rate is P1 to P2, in order to reduce black float.

Then, the Max luminance becomes maximum when the average lighting rate increases from the state of 0 and the average lighting rate reaches the point P2. The duty of the LED at this time is 100% (Max luminance A). Further, as the average lighting rate becomes higher than the point P2, power that is able to be supplied in each LED is reduced by power limit control, and therefore the possible maximum luminance of a region is also decreased gradually. The point P3 is a state where the entire screen is completely lit, and in the case of the present example, the duty of each LED is reduced to, for example, 36.5%.

The power limit control is for further enhancing luminance of the backlight with respect to a region that needs more luminance in a display screen to improve contrast. Here, a total quantity of drive current when LEDs of the backlight are completely lit is set to an upper limit, and light emission luminance of the LED is increased at fixed multiplying factor in a range where a total quantity of drive current of LEDs that are lit in each region does not exceed the total quantity of drive current when completely lit.

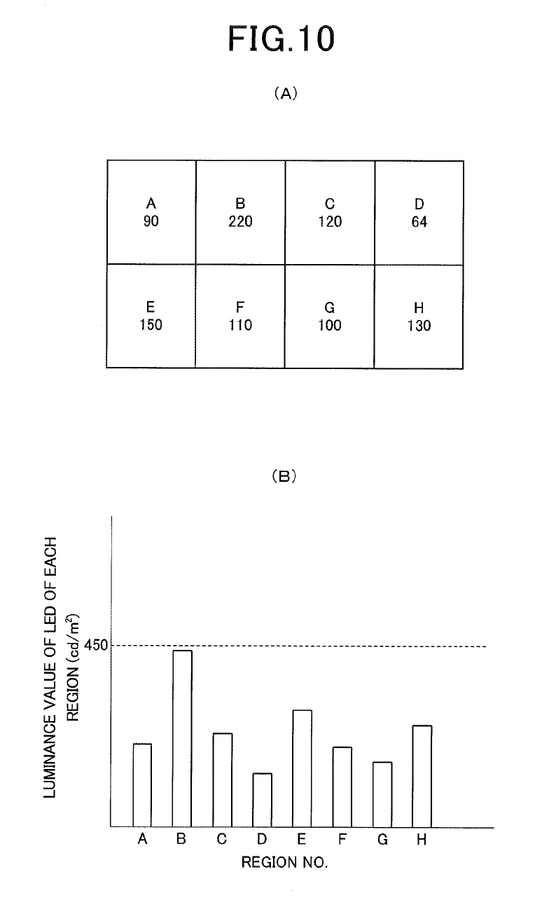

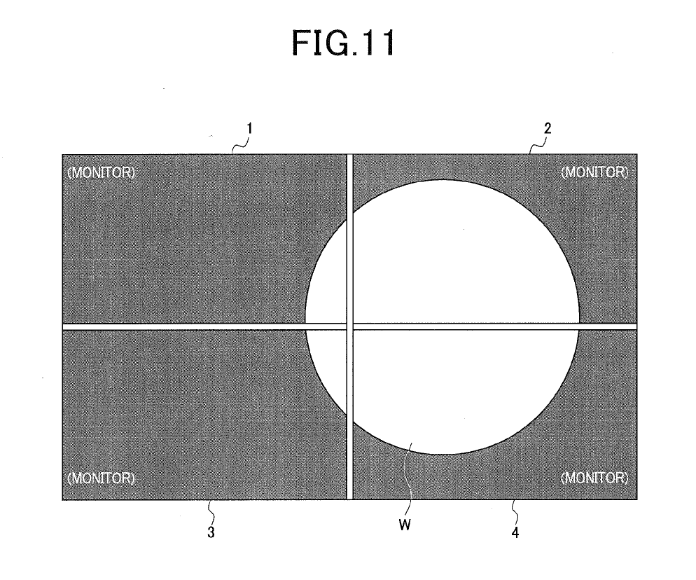

Specifically, as shown in FIG. 4, light emission luminance (first luminance) of the LED, which is defined for each region in FIG. 10(B), is multiplied by fixed multiplying factor (a-times) to enhance luminance. That is, the luminance stretch quantity described above is determined according to this fixed multiplying factor (a-times). The condition at this time is a total quantity of drive current values of each region <a total drive current value when LEDs are completely lit. In this case, in a single region, it is allowed to exceed the luminance when completely lit (for example, 450 cd/m²), and much more drive current is supplied to the LED in a range having enough power to make brighter. Performing such control makes it possible to actually provide double or triple peak luminance. The light emission luminance of the LED exemplified in FIG. 4 corresponds to second luminance that the first luminance is multiplied by a.

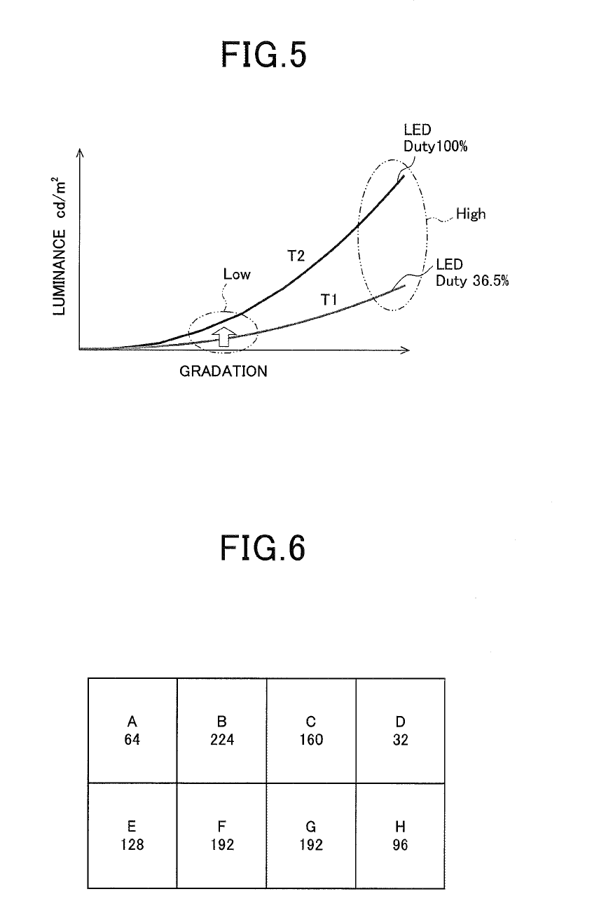

FIG. 5 is a diagram showing a state of luminance on a liquid crystal panel when a luminance duty of the LED is shifted. A horizontal axis indicates gradation of a video signal (pixel gradation) and a vertical axis indicates a luminance value on the liquid crystal panel. For example, when the LED of the LED backlight 17 is controlled with a duty of 36.5%, gradation representation of the video signal becomes like T1. At this time, a luminance value on the liquid crystal panel=(gradation value)^{2.2} (that is, gamma=2.2). When the LED is controlled with a duty of 100%, gradation representation becomes like T2. That is, since the luminance of the LED is increased by about 2.7 times from 36.5% to 100%, the luminance value on the liquid crystal panel is also increased by about 2.7 times. At this time, the luminance is increased by about 2.7 times in both a High region having high luminance for which feeling of brightness is desirably increased and a Low region of a low-gradation part.

FIG. 6 is a diagram showing an example that a display screen is divided into eight. Each divided region No. is set as A to H, which shows a maximum gradation value of a video signal for each region. Here, a first feature quantity of the present invention is set as a maximum gradation value for each region, but, in addition, other statistic such as an average of gradation values in a region may be used. In the present example, maximum gradation values of the video signal in the eight divided regions are, for example, 64, 224, 160, 32, 128, 192, 192 and 96, and an average of the maximum gradation values becomes a value of 53% with respect to 256th gradation level. That is, in this case, it corresponds to the average lighting rate (window size) of 53% at the point P4 in the graph of FIG. 3 described above.

Here, for each of the regions of No. A to H, from a maximum gradation value in the region, a lighting rate of the LED of the LED backlight 17 in the region is calculated. This lighting rate is able to be indicated by, for example, a drive duty (LED duty) of the LED backlight 17. In this case, a maximum value of the lighting rate is 100%. Note that, as described above, the luminance of the LED is controlled to have a desired value by PWM and/or current control.

When determining the lighting rate of the LED of each region, the lighting rate is decreased to reduce the luminance of the backlight for a dark region where the maximum gradation value is low. As an example, when being represented by 8-bit data with a gradation value of a video of 0 to 255, if the maximum gradation value is 128, the lighting rate of the backlight is decreased to (1/(255/128))^{2.2}=0.217 time (21.7%). The lighting rate of each region is calculated according to a predefined operation expression in such a way as to reduce the luminance of the backlight for a dark low-gradation region, basically without reducing backlight luminance for a bright high-gradation region.

The image analysis portion 131a averages lighting rates of the backlight for each region calculated from the maximum gradation value of the video signal to calculate the average lighting rate of the LED backlight 17 in a single frame. The calculated average lighting rate of the entire screen, of course, becomes high as a region having a high lighting rate increases in each region. An actual value of the average lighting rate in the example of FIG. 6 is about 53%.

For example, it is set that the duty of the LED corresponding to luminance of the LED backlight 17 in a region that possibly has maximum luminance is 55% when the average lighting rate is 53% (P4) in FIG. 3 described above. That is, it is possible to increase the LED backlight 17 up to around the duty of 55% by power limit control when the average lighting rate in this screen is 53%. The duty of 55% at this time corresponds to about 1.5 times of the duty of 36.5% when completely lit (average lighting rate of 100%). That is, when the average lighting rate is 53% with respect to the duty of 36.5% of the LED when LEDs are completely lit, it is possible to supply power to the lighting LED to have luminance which is about 1.5 times of the duty of 36.5%.

In view of the above, light emission luminance (first luminance) of the LED, which is defined for each region, is multiplied by fixed multiplying factor a when the average lighting rate is 53%=1.5 (this multiplying factor a is also referred to as a luminance increasing rate or a duty increasing rate), to acquire second luminance that peak luminance is enhanced for each region. In this manner, by performing PWM control so that power does not exceed a prescribed value and supplying power locally when a lit area is small to enhance peak luminance, it is possible to provide higher luminance compared to normal local dimming.

In this manner, the gradation control portion 131b defines the first luminance of the LED for each divided region according to the first feature quantity of the video signal in each divided region, which is acquired by the image analysis portion 131a, and further multiplies the first luminance in each divided region by the fixed multiplying factor for stretching the first luminance uniformly in a range where a total value of LED drive current is equal to or less than a predetermined allowable current value, thereby defining the second luminance for each region. Note that, the first feature quantity is, for example, a maximum gradation value, and the fixed multiplying factor (luminance stretch quantity) is determined based on the average lighting rate of the LED backlight 17. The first luminance is exemplified in FIG. 10(B) and the second luminance is exemplified in FIG. 4.

Moreover, the gradation control portion 131b may perform power limit control based on an APL (Average Picture Level) of the video signal, instead of the average lighting rate of the LED backlight 17. The APL is able to be acquired by analyzing the video signal by the image analysis portion 131a. Since this APL is an average value of gradation of the entire video signal, when the APL of the video signal is low, the average lighting rate of the LED backlight 17 is also low, and when the APL of the video signal is high, the average lighting rate of the LED backlight 17 is also high. Accordingly, it is possible to perform the same control even when the APL is taken along the horizontal axis of FIG. 3.

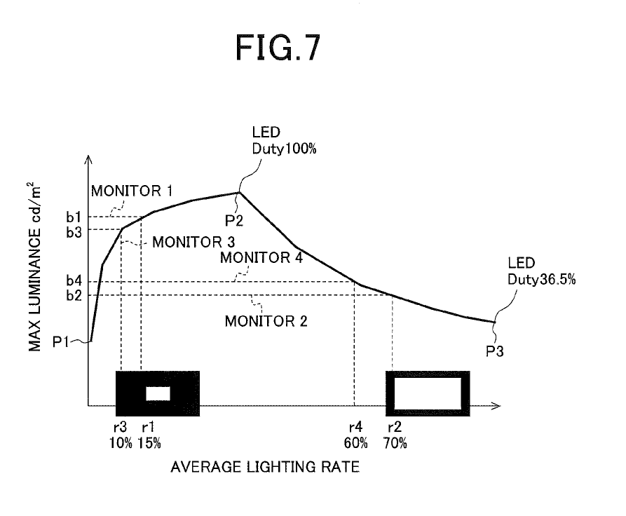

Though description has been given above for the case where power limit control is performed independently for each of the monitors 1 to 4, when the video like in FIG. 1 described above is assumed, there is a problem that variations in luminance of the white circle part W in the monitors 1 to 4 occur by power limit control. This will be described based on FIG. 1 and FIG. 7. A control function of FIG. 7 is the same as the control function of FIG. 3. The video of FIG. 1 is displayed on the monitors 1 to 4, in which pixel gradation of the video signal of the white circle part W is 255 and pixel gradation of other black part is 0. In the monitors 1 and 3, proportion of the white circle part W having peak luminance to the entire screen is low and the average lighting rates (or APLs) are r1 (=15%) and r3 (=10%), respectively. In this case, since a lit area of the LED becomes small, such control is performed that power is supplied locally to cause the LED to emit light with high intensity, so that the luminance of the white circle part W becomes high. In the example of FIG. 7, the Max luminance of the monitor 1 is b1 and the Max luminance of the monitor 3 is b3.

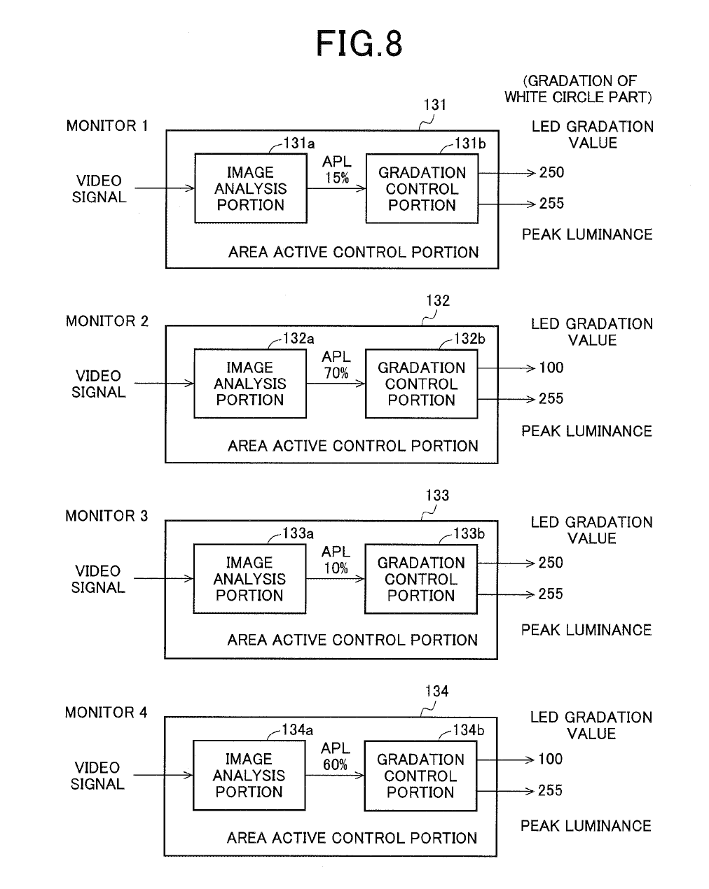

On the other hand, in the monitors 2 and 4, proportion of the white circle part W having peak luminance to the entire screen is high and the average lighting rates (or APLs) are r2 (=70%) and r4 (=60%), respectively. In this case, since a lit area of the LED becomes large, such control is performed as to cause the LED to emit light with low intensity, so that the luminance of the white circle part W becomes low. In the example of FIG. 7, the Max luminance of the monitor 2 is b2 and the Max luminance of the monitor 4 is b4. Thereby, the Max luminance of the monitors 1 to 4 is b2, b4, b3 and b1 in ascending order and the first luminance of each of the monitors 1 to 4 is stretched according to these Max luminance b2, b4, b3 and b1, respectively, so that variations in the luminance of the white circle part W in each of the monitors 1 to 4 occur. This will be described based on FIG. 8.

FIG. 8 is a diagram explaining exemplary control when power limit control is performed individually for each of the monitors 1 to 4. Similarly to the monitor 1, the monitor 2 is provided with an area active control portion 132, and the area active control portion 132 is provided with an image analysis portion 132a and a gradation control portion 132b. The monitor 3 is provided with an area active control portion 133, and the area active control portion 133 is provided with an image analysis portion 133a and a gradation control portion 133b. The monitor 4 is provided with an area active control portion 134, and the area active control portion 134 is provided with an image analysis portion 134a and a gradation control portion 134b. Note that, in the present example, description will be given for a case where, when the video signal of FIG. 1 is displayed on each of the monitors 1 to 4, an APL of the video signal is used instead of the average lighting rate of the LED backlight 17.

In the case of the monitor 1, since proportion of the white circle part W is small, it is controlled to cause the LED to emit light with high intensity. First, when the video signal of FIG. 1 is input to the image analysis portion 131a, this video signal is analyzed to acquire an APL from the video signal. The APL is acquired as 15% in the monitor 1. Next, the APL (15%) acquired by the image analysis portion 131a is input to the gradation control portion 131b, and in the gradation control portion 131b, the Max luminance b1 is acquired as possible maximum display luminance on the screen of the liquid crystal panel 18 by referring to the graph of FIG. 7 based on the APL (15%).

The gradation control portion 131b defines the first luminance of the LED for each divided region according to the maximum gradation value of the video signal in each divided region acquired by the image analysis portion 131a as described above, and further multiplies the first luminance in each divided region by the fixed multiplying factor for stretching the first luminance uniformly in a range where a total value of LED drive current is equal to or less than a predetermined allowable current value, thereby defining the second luminance for each region. That is, the gradation control portion 131b determines the fixed multiplying factor (luminance stretch quantity) by the Max luminance b1, and defines the second luminance by multiplying the first luminance by the determined fixed multiplying factor. The gradation control portion 131b determines a maximum LED gradation value corresponding to the maximum luminance of this second luminance, that is, an LED gradation value of the white circle part W. Note that, the maximum LED gradation value is determined based on an LED duty at a time of the Max luminance b1 (that is, the maximum luminance of the second luminance). In FIG. 7 described above, the maximum LED gradation value for the Max luminance b1 is 250.

In view of the above, the gradation control portion 131b performs output with the LED gradation value as 250 and the peak luminance as 255 for the white circle part W. Note that, in the case of the example of FIG. 1, the peak luminance is a pixel gradation value of the white circle part W, which is 255 here. By performing such gradation control, the maximum display luminance on the screen is controlled to be the Max luminance b1. Note that, in the monitor 3 as well, since proportion of the white circle part W is small and the LED is caused to emit light with high intensity, output is performed with the LED gradation value as 250 and the peak luminance as 255 for the white circle part W, in the same manner as the case of the monitor 1. By performing such gradation control, the maximum display luminance on the screen is controlled to be the Max luminance b3.

Moreover, in the case of the monitor 2, proportion of the white circle part W is large, so that it is controlled to cause the LED to emit light with low intensity. First, when the video signal of FIG. 1 is input to the image analysis portion 132a, this video signal is analyzed to acquire an APL from the video signal. The APL is acquired as 70% in the monitor 2. Next, the APL (70%) acquired by the image analysis portion 132a is input to the gradation control portion 132b, and in the gradation control portion 132b, the Max luminance b2 is acquired as maximum possible display luminance on the screen of the liquid crystal panel 18 by referring to the graph of FIG. 7 based on the APL (70%).

The gradation control portion 132b then determines an LED gradation value of the white circle part W so that the maximum display luminance on the screen becomes the Max luminance b2, and outputs the determined LED gradation value of the white circle part W. Specifically, the gradation control portion 132b performs output with the LED gradation value as 100 and the peak luminance as 255 for the white circle part W. By performing such gradation control, the maximum display luminance on the screen is controlled to be the Max luminance b2. Note that, in the monitor 4 as well, since proportion of the white circle part W is large and the LED is caused to emit light with low intensity, output is performed with the LED gradation value as 100 and the peak luminance as 255 for the white circle part W, in the same manner as the case of the monitor 2. By performing such gradation control, the maximum display luminance on the screen is controlled to be the Max luminance b4.

In view of the above, the Max luminance of the monitors 1 to 4 becomes b2, b4, b3 and b1 in an ascending order, variations in the fixed multiplying factor (luminance stretch quantity) of each of the monitors 1 to 4 occur, and the luminance (LED gradation) of the white circle part W becomes non-uniform.

A main object of the present invention is, in a video display device in which a single screen is constituted by a plurality of monitors, when a backlight is divided into a plurality of regions to control luminance of the backlight according to a video signal corresponding to each of the regions, to enable suppressing variations in luminance among the monitors while achieving high contrast feeling. As the configuration therefor, each of the gradation control portions 131b to 134b of the monitors 1 to 4 defines first luminance of an LED for each divided region according to a first feature quantity (for example, maximum gradation value) acquired by each of the image analysis portions 131a to 134a, and further calculates a luminance stretch quantity for stretching the first luminance uniformly in a range where a total value of LED drive current is equal to or less than a predetermined allowable current value, with respect to the first luminance in each divided region. This luminance stretch quantity (that is, fixed multiplying factor) is able to be acquired according to the Max luminance b1 to b4 shown in FIG. 7 as described above.

Further, the video display device is provided with a microcomputer 19 that selects a minimum luminance stretch quantity which is minimum from among the luminance stretch quantities acquired from each of the monitors 1 to 4 and outputs the selected minimum luminance stretch quantity to each of the monitors 1 to 4. This microcomputer 19 corresponds to a control portion of the present invention. Each of the gradation control portions 131b to 134b of the monitors 1 to 4 defines second luminance for each region by stretching the first luminance uniformly based on the minimum luminance stretch quantity acquired from the microcomputer 19. Specifically, each of the gradation control portions 131b to 134b of the monitors 1 to 4 defines the second luminance by multiplying the first luminance by fixed multiplying factor according to the minimum luminance stretch quantity acquired from the microcomputer 19 to acquire a maximum LED gradation value from maximum luminance of the second luminance.

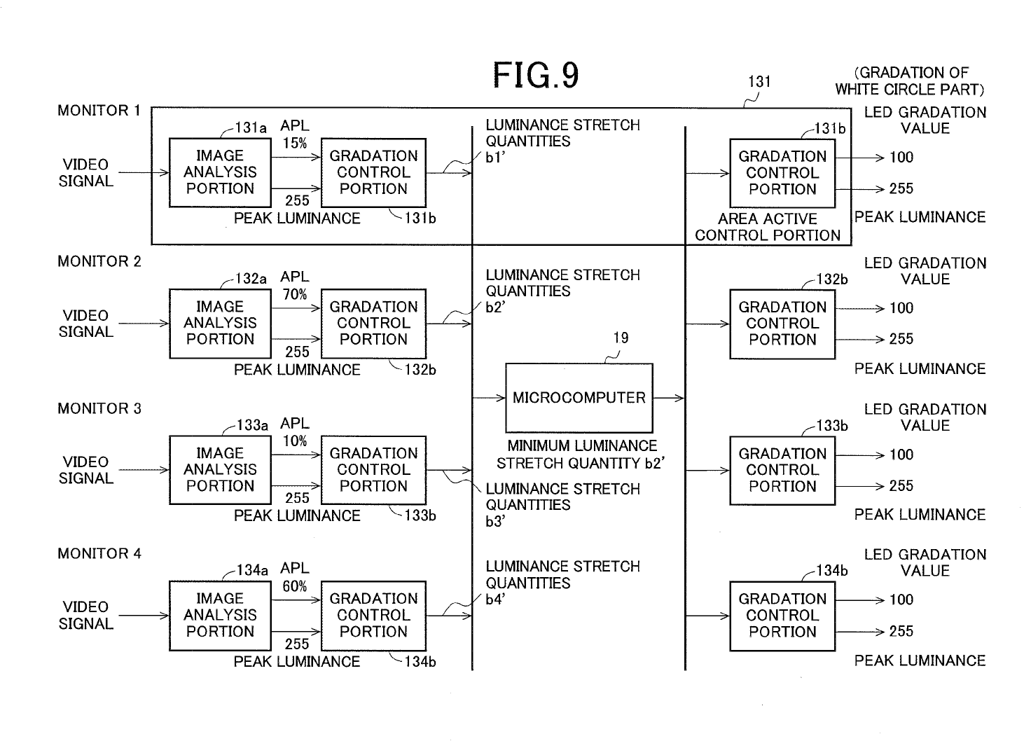

FIG. 9 is a diagram explaining exemplary control of power limit control by the video display device according to the present invention. Each of the gradation control portions 131b to 134b of the monitors 1 to 4 inputs an APL and peak luminance of the video signal from the image analysis portions 131a to 134a. As the video signal, it is set that the video same as the example of FIG. 1 is input. Note that, the control function of FIG. 7 described above is stored in a not-shown memory and referred to based on the average lighting rate of the LED backlight 17, which is acquired from the video signal, or the APL of the video signal. In the case of the present example, the APL of the video signal input to the monitor 1 is 15%, the APL of the video signal input to the monitor 2 is 70%, the APL of the video signal input to the monitor 3 is 10%, and the APL of the video signal input to the monitor 4 is 60%. These APLs are the same as the example of FIG. 8. Moreover, the peak luminance of the video signals input to the monitors 1 to 4 is common at 255.

The gradation control portions 131b to 134b refer to the control function of FIG. 7 based on the APLs input from the image analysis portions 131a to 134a, and specify the Max luminance corresponding to the APLs 15%, 70%, 10%, and 60% in the order of the monitors 1 to 4. In the case of the present example, in the same manner as the example of FIG. 7, the Max luminance b1, b2, b3 and b4 are acquired in the order of the monitors 1 to 4, and each of luminance stretch quantities b1′, b2′, b3′ and b4′ is calculated from these Max luminance. The microcomputer 19 acquires the luminance stretch quantities b1′, b2′, b3′ and b4′ from each of the monitors 1 to 4, selects a minimum luminance stretch quantity which is minimum from among the acquired luminance stretch quantities b1′, b2′, b3′ and b4′, and outputs the selected minimum luminance stretch quantity to each of the monitors 1 to 4. Here, the luminance stretch quantity b2′ corresponding to the Max luminance b2 is selected.

The gradation control portion 131b of the monitor 1 defines first luminance of an LED for each divided region according to the maximum gradation value of the video signal of each divided region acquired by the image analysis portion 131a. Then, the gradation control portion 131b multiplies the first luminance in each divided region by the fixed multiplying factor for stretching the first luminance in a range where a total value of LED drive current is equal to or less than a predetermined allowable current value, thereby defining second luminance for each region. At this time, the gradation control portion 131b multiplies the first luminance by the fixed multiplying factor according to the minimum luminance stretch quantity b2′ acquired from the microcomputer 19 to define the second luminance, thereby acquiring a maximum LED gradation value from the maximum value of the second luminance.

In FIG. 7 described above, it is set that a duty of the LED corresponding to the luminance of the LED backlight 17 of a region which possibly has maximum luminance is, for example, 45% at a time of the Max luminance b2 (APL 70%). That is, at a time of the APL of 70% on this screen, it is possible to increase the LED backlight 17 up to a duty equivalent to 45% by power limit control. Since the duty of 45% at this time is about 1.2 times of the duty of 36.5% when completely lit (APL of 100%), it is possible to determine the above-described fixed multiplying factor as 1.2. Accordingly, the second luminance is defined by multiplying the first luminance by 1.2.

The gradation control portion 131b then defines the second luminance by multiplying the first luminance by the above-described fixed multiplying factor (1.2 in the present example) and acquires a maximum LED gradation value from maximum luminance of the second luminance, which corresponds to the LED gradation value of the white circle part W shown in FIG. 1. In the case of the present example, the white circle part W of the monitor 1 has the LED gradation value of 100 and the peak luminance of 255, and by performing such gradation control, it is possible to match the maximum display luminance of the monitor 1 to the Max luminance b2.

As to the monitors 2 to 4 as well, similarly to the above, the gradation control portions 132b to 134b determine fixed multiplying factor (1.2 in the present example) by the Max luminance b2 and multiply the first luminance by the determined fixed multiplying factor to define second luminance. Then, the gradation control portions 132b to 134b of the monitors 2 to 4 acquire a maximum LED gradation value from maximum luminance of the second luminance, similarly to the monitor 1. Thereby, the gradation control portions 132b to 134b determine the LED gradation value of the white circle part W as 100, similarly to the monitor 1. By performing such gradation adjustment, it is possible to match the maximum display luminance of the monitors 2 to 4 to the Max luminance b2.

Note that, as described above, since the peak luminance of the video signals in the monitors 1 to 4 is the same at 255, each of the monitors has the same value of the maximum gradation value. Further, since the first luminance of each of the monitors is defined based on the maximum gradation value, each of the monitors has the same value of the maximum luminance of the first luminance as well. Since the maximum luminance of the first luminance is multiplied by the fixed multiplying factor by the Max luminance b2 in the monitors 1 to 4, the maximum luminance of the second luminance is conformed among the monitors 1 to 4. Then, the maximum LED gradation value is acquired from the maximum luminance of the second luminance. As a result, since the LED gradation value and the peak luminance of the white circle part W are all conformed with the LED gradation value and the peak luminance in the monitor 2 in the monitors 1 to 4, it is possible to conform the maximum display luminance of each of the monitors with the Max luminance b2.

That is, by matching the maximum display luminance of each of the monitors 1 to 4 to the display luminance of the monitor 2, which is minimum among the maximum display luminance of each of the monitors, it is possible to conform the luminance among the monitors. In addition, since the luminance is stretched only by the luminance stretch quantity according to the Max luminance b2, it is possible to suppress variations in luminance among the monitors while achieving high contrast feeling.

Here, each of the monitors 1 to 4 is adjusted to have the maximum display luminance of each of the monitors by power limit control. Therefore, it is necessary to match luminance of each of the monitors to the display luminance of the monitor which has the minimum one among the maximum display luminance of each of the monitors for conforming. Thus, in the present invention, the maximum display luminance of each of the monitors is matched to the display luminance of the monitor which has the minimum one among the maximum display luminance of each of the monitors so that display luminance is conformed among the monitors.

As described above, according to the present invention, in a video display device in which a single screen is constituted by a plurality of monitors, when a backlight is divided into a plurality of regions to control luminance of the backlight according to a video signal corresponding to each of the regions, a luminance ratio among regions is increased to improve contrast as well as power is supplied locally to enhance peak luminance when an area where the backlight is lit is small, and further luminance of a peak part (such as a white part) in each monitor is matched to luminance of a monitor where the luminance of the peak part becomes minimum, thus making it possible to suppress variations in luminance among the monitors while achieving high contrast feeling.

### EXPLANATIONS OF LETTERS OR NUMERALS

1-4 . . . monitor, 11 . . . image processing portion, 121-124 . . . LED control module, 131-134 . . . area active control portion, 131a-134a . . . image analysis portion, 131b-134b . . . gradation control portion, 14 . . . LED control portion, 15 . . . LED driver, 16 . . . timing controller, 17 . . . LED backlight, 18 . . . liquid crystal panel, and 19 . . . microcomputer.

1.-5. (canceled)

6. A video display device in which a single screen is constituted by a plurality of monitors, wherein
each of the monitors includes a display panel that displays a video signal,
a backlight that uses an LED as a light source for illuminating the display panel,
an image analysis portion that divides the backlight into a plurality of regions to acquire a first feature quantity of a video of a display region corresponding to each of the divided regions, and
a gradation control portion that defines first luminance of the LED for each of the divided regions according to the first feature quantity acquired by the image analysis portion, and further calculates a luminance stretch quantity for enhancing the first luminance uniformly, with respect to the first luminance for each of the divided regions,
the luminance stretch quantity is the same in a range where a total value of LED drive current per monitor is equal to or less than a predetermined allowable current value, and among each of the monitors, and
the gradation control portion of each of the monitors enhances the first luminance uniformly based on the luminance stretch quantity to define second luminance for each region.

7. The video display device as defined in claim 6, wherein
the image analysis portion of each of the monitors varies a lighting rate of the backlight corresponding to the divided region based on the first feature quantity of the video signal of the divided region and acquires an average lighting rate of all regions of the backlight by averaging lighting rates of the backlight of each of the divided regions, and
the gradation control portion of each of the monitors acquires the luminance stretch quantity based on maximum possible display luminance on a screen of the display panel associated with the average lighting rate in advance.

8. The video display device as defined in claim 6, wherein
the image analysis portion of each of the monitors acquires an APL of the video signal which is different from the first feature quantity, and
the gradation control portion of each of the monitors acquires the luminance stretch quantity based on maximum possible display luminance on a screen of the display panel associated with the APL in advance.

9. The video display device as defined in claim 6, wherein
the gradation control portion of each of the monitors defines the second luminance by multiplying the first luminance by a fixed multiplying factor according to a minimum luminance stretch quantity selected from among the luminance stretch quantities acquired from each of the monitors, and acquires a maximum LED gradation value from maximum luminance of the second luminance.

10. The video display device as defined in claim 6, wherein
the first feature quantity is a maximum gradation value of the video signal in the divided region.
